(19) United States
(12) Patent Application Publication
(10) Pub. No.: US 2011/0032643 A1
(43) Pub. Date: Feb. 10, 2011

(54) EXCHANGE COUPLED COMPOSITE (ECC) PMR MEDIA WITHOUT PROTECTIVE LAYER THROUGH SOFT-FERRITE

(76) Inventor: Sooyoul Hong, Seoul (KR)

Correspondence Address: IRELL & MANELLA LLP, 1800 AVENUE OF THE STARS, SUITE 900, LOS ANGELES, CA, 90067, US

(21) Appl. No.: 12/536,111

(22) Filed: Aug. 5, 2009

(51) Int. Cl. G11B 5/55; G11B 23/03; B05D 5/00

(52) U.S. Cl. 360/266.4; 360/133; 427/131; G9B/23.02; G9B/5.182

(57) ABSTRACT

A disk for a hard disk drive. The disk includes a first magnetic layer supported by a substrate and an intermediate layer adjacent to the first magnetic layer. The disk also includes a second magnetic layer that is adjacent to the intermediate layer and includes barium. The barium second magnetic layer has a mechanical hardness so that a protective layer such as COC is not required for the disk.

### BACKGROUND OF THE INVENTION

1. Field of the Invention

The subject matter disclosed generally relates to disk media of hard disk drives.

2. Background Information

Hard disk drives contain a plurality of heads that are magnetically coupled to rotating disks. The heads write and read information by magnetizing and sensing the magnetic fields of the disk surfaces.

Each head has an air bearing surface that interacts with a flow of air within the disk drive (created by the rotating disk) to create an air bearing. The air bearing prevents contact between the head and disk and mechanical wear of the disk surface. Present air bearings are very small and may allow contact between the head and disk surface.

Some disk structures contact an exchange coupled composite (“ECC”) that includes a top soft magnetic layer. A carbon over coat (“COC”) is formed over the soft magnetic layer to protect the soft magnetic material. The COC layer increases the distance between the head and the underlying magnetic layer. It is desirable to minimize the distance between the head and the magnetic material of the disk to optimize disk magnetization.

### BRIEF SUMMARY OF THE INVENTION

A disk for a hard disk drive. The disk includes a first magnetic layer supported by a substrate and an intermediate layer adjacent to the first magnetic layer. The disk also includes a second magnetic layer that is adjacent to the intermediate layer and includes barium.

### BRIEF DESCRIPTION OF THE DRAWINGS

FIG. 1 is a top view of a hard disk drive;

FIG. 2 is an illustration of a disk of the hard disk drive.

### DETAILED DESCRIPTION

Disclosed is a disk for a hard disk drive. The disk includes a first magnetic layer supported by a substrate and an intermediate layer adjacent to the first magnetic layer. The disk also includes a second magnetic layer that is adjacent to the intermediate layer and includes barium. The barium second magnetic layer has a mechanical hardness so that a protective layer such as COC is not required for the disk.

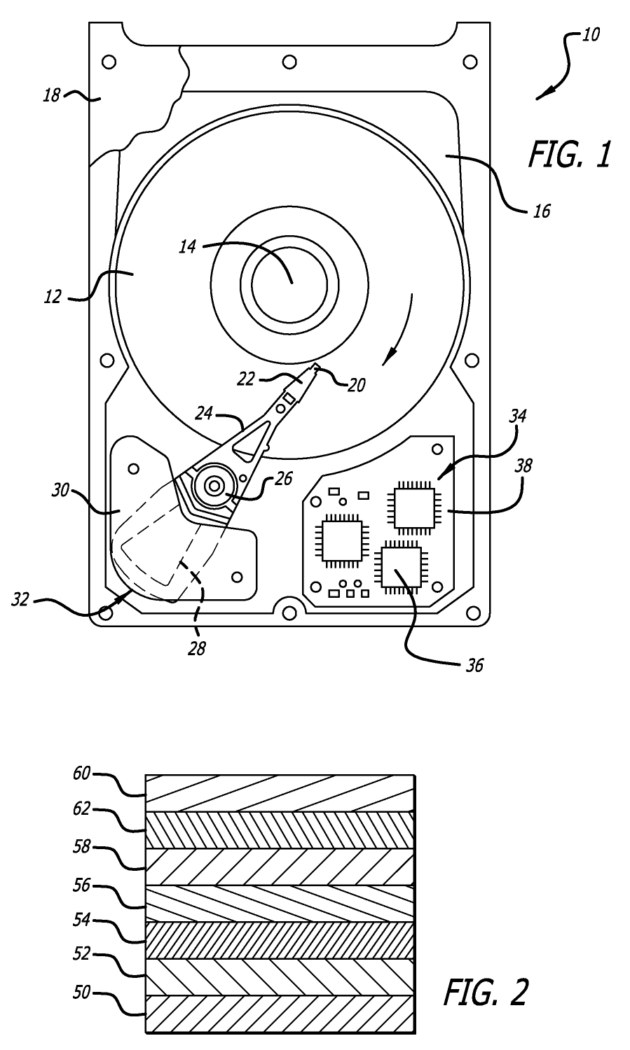

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

FIG. 2 shows an embodiment of the disk 12. The disk 12 includes a substrate 50 that supports a layer of material 52. The disk may further have a seed layer 54 and a layer of material 56.

The disk 12 also has a hard magnetic layer 58 and a soft magnetic layer 60 separated by an intermediate layer 62. The intermediate 62 and magnetic layers 58 and 60 create a exchange coupled composite (“ECC”).

The soft magnetic layer 60 includes barium (Ba). The barium composition creates a magnetic layer that is chemically stable and has a hardness the eliminates the need for a protective overcoat found in prior art disks. By way of example, the soft magnetic layer may include a composition of BaFe₁₂₋₁₂ₓCoₓTiₓO₁₉.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A magnetic disk for a hard disk drive, comprising:
a substrate;
a first magnetic layer supported by said substrate;
an intermediate layer adjacent to said first magnetic layer; and,
a second magnetic layer adjacent to said intermediate layer, said second magnetic layer includes barium.

2. The disk of claim 1, wherein said second magnetic layer is an outermost layer of the disk.

3. The disk of claim 1, wherein said second magnetic layer includes iron.

4. The disk of claim 1, wherein said second magnetic layer includes cobolt and titanium.

5. A hard disk drive, comprising:
a base plate;
a spindle motor coupled to said base plate;
a disk coupled to said spindle motor, said disk including;
a substrate;
a first magnetic layer supported by said substrate;
an intermediate layer adjacent to said first magnetic layer;
a second magnetic layer adjacent to said intermediate layer, said second magnetic layer includes barium;
an actuator arm mounted to said base plate;
a voice coil motor coupled to said actuator arm; and,
a head coupled to said actuator arm and said disk.

6. The hard disk drive of claim 5, wherein said second magnetic layer is an outermost layer of the disk.

7. The hard disk drive of claim 5, wherein said second magnetic layer includes iron.

8. The hard disk drive of claim 5, wherein said second magnetic layer includes cobolt and titanium.

9. A method for fabricating a disk of a hard disk drive, comprising:
forming a first layer of magnetic material over a substrate;
forming an intermediate layer over the first layer of magnetic material; and,
forming a second layer of magnetic material that includes barium over the intermediate layer.

10. The method of claim 9, wherein the second layer of magnetic material is the outermost layer of the disk.

11. The method of claim 9, wherein the second layer of magnetic material includes iron.

12. The method of claim 9, wherein the second layer of magnetic material includes cobolt and titanium.
